(19) United States
(12) Patent Application Publication
(10) Pub. No.: US 2022/0144033 A1
(43) Pub. Date: May 12, 2022

(54) METHOD FOR OPERATING A COMPRESSED AIR SUPPLY DEVICE, AND COMPRESSED AIR SUPPLY DEVICE

(71) Applicant: Continental Teves AG & Co. OHG, Frankfurt am Main (DE)

(72) Inventor: Christian Witala, Hannover (DE)

(73) Assignee: Continental Teves AG & Co. OHG, Frankfurt am Main (DE)

(21) Appl. No.: 17/443,290

(22) Filed: Jul. 23, 2021

(30) Foreign Application Priority Data
Jul. 24, 2020 (DE) 10 2020 209 390.3

(51) Int. Cl. B60G 13/14

(52) U.S. Cl. CPC B60G 13/14; B60G 2204/201

(57) ABSTRACT

A compressed air supply device for an air suspension system of a motor vehicle comprising a motor-driven compressor, a dryer, a discharge path from the dryer to the outside, and an adjustment device for changing a flow cross section of the discharge path is provided in the discharge path.

### CROSS-REFERENCE TO RELATED APPLICATIONS

The present application claims priority under 35 U.S.C. § 119 to German Patent Application No. 10 2020 209 390.3, filed on Jul. 24, 2020, in the German Patent and Trademark Office, the disclosure of which is herein incorporated by reference in its entirety.

### BACKGROUND

### 1. Field

Embodiments relate to a method for operating a compressed air supply device, and to a compressed air supply device.

### 2. Description of Related Art

Compressed air supply devices for electronically controlled air suspension systems essentially comprise a compressor which is driven via a motor, a dryer unit and several switching valves. For operating the air suspension system, the compressor draws in air from the atmosphere, compresses this and supplies it to the consumers of the air suspension system.

However, the intake ambient air contains water or moisture, which can lead to freezing of individual components, such as the switching valves. To prevent this, the dew point of the intake air is lowered by means of the dryer. In other words, the air is dried or dehumidified by means of a desiccant/adsorbent such as silica gel. The intake air thus releases its moisture to the desiccant and is then directed into the air springs or a pressure accumulator.

The task of the dryer is therefore to dry the air drawn into the air suspension system. Above a certain point, the dryer must be regarded as saturated because the adsorbent has already absorbed a large quantity of moisture and therefore can only fulfil its drying function to a limited extent. Therefore the dryer must be regularly regenerated so as to guarantee a reliable drying function.

The dryer is regenerated by means of desorption. This means that the moisture contained in the adsorbent is absorbed using through-flowing air and released to the environment. For this, dry compressed air is taken from the air suspension system. For example, in a lowering process, the compressed air flows from the air springs through the dryer in order to regenerate the latter. In this process, the compressed air flows from the air springs through the dryer in counterflow and is released to the environment via a discharge valve. Since the lowering process is usually intended to take place quickly, the cross section of the discharge valve is chosen to be large. However, a large flow cross section also causes rapid venting of the dryer. For efficient regeneration however, a slow flow through the dryer is advantageous.

At higher air temperatures, the moisture can also be extracted better from the adsorbent. Therefore, for efficient regeneration, heated air is advantageous. However, the system air in the air suspension system usually corresponds to the ambient temperature which prevails in the components such as the air springs or pressure accumulator. Thus a poorer regeneration efficiency is achieved.

Therefore, in the prior art, DE 10 2010 036 742 A1 proposes using the waste heat from the compressor or motor. In the air supply system described therein, the heat occurs substantially as compression heat or in the form of waste heat from the electric drive motor. These heat types are used to support the dryer regeneration in that a direct thermal coupling is created between the dryer or desiccant and the heat sources in the air supply system. The desiccant heated in this way releases the contained water better to the through-flowing air. This increases the effectiveness of the dryer regeneration. Consequently, a smaller quantity of regeneration air is required for systems with closed air supply, while the dryer is regenerated better in open air supply systems.

In open air supply systems, the necessary quantities of regeneration air are usually possible only on unloading of the air suspension system from full load to no load. These are however exceptional cases, since during operation, more often a load change takes place between two people with luggage and no load, which however leads to small quantities of regeneration air with correspondingly poor desorption. In a closed air supply system, the described possibilities for air discharge are not present for system reasons. Here, after initial filling of the system, only part of the system air may be used for regeneration, since otherwise the system is not filled. This part should be as small as possible in order to keep the compressor run times for filling as short as possible. In these cases, the air is usually controlled by the actuators which are present in any case, such as the air spring valve, pressure accumulator valve, changeover valve in closed systems, or discharge valve.

As a result, there is always a risk of breakthrough of water or moisture into the system. This is the case in particular if, because of leakages in the air suspension system, only limited system air is available for regeneration of the dryer because the compressor must permanently fill the system with air.

### SUMMARY

It is therefore an object of the invention to improve the regeneration of the dryer of a compressed air supply device.

The object on which the invention is based is achieved with the features of the method claim and the associated device claim. Preferred embodiments will be found in the respective dependent claims.

According to the invention, a method is provided for operating a compressed air supply device, wherein the compressed air supply device comprises a motor-driven compressor and a dryer, wherein a discharge path leads from the dryer to the outside, wherein to regenerate the dryer, a regeneration process is performed which takes place with a compressed air quantity which is exclusively contained in the dryer.

If a certain quantity of compressed air is present in the dryer, this is used for undertaking a regeneration of the dryer. Part of the moisture present in the dryer is absorbed by the compressed air present therein and released to the environment via the opened discharge path. This regeneration process therefore has the advantage that the dryer is regenerated directly with the contained compressed air. Accordingly, this regeneration process already leads to a partial regeneration of the dryer.

The compressed air supply device can be connected to an air suspension device. On the device side, the switching valves of the air suspension device then remain closed for the regeneration process, so that the regeneration process takes place exclusively with compressed air contained in the dryer, and no compressed air from the air suspension device flows through the dryer during this regeneration process.

The regeneration of the dryer takes place particularly efficiently at high air temperatures. Therefore the regeneration process preferably takes place after a compression process of the compressor. Thus it is advantageous to utilize the heated compressed air after a compression process. During the compression of air, the temperature of the compressed air quantity rises. During the compression process, this quantity of compressed air is conducted through the dryer, while the moisture contained in the compressed air is adsorbed. The compressed air collected in the dryer after the compression process still has a temperature value which is higher than the ambient temperature. As long as the compressed air contained in the dryer after the compression process has not yet cooled, it is advantageously used to carry out a regeneration of the dryer. It is therefore highly advantageous if the regeneration process takes place temporally directly after the compression process. Thus preferably the regeneration process takes place directly after the compression process of the compressor. Particularly preferably, this compression process first heats the compressed air quantity for the regeneration process to a temperature value within a temperature range between 60 and 100° C. The higher the temperature of the compressed air in the dryer, the better it absorbs the moisture captured in the dryer and releases this to the outside on discharge via the discharge path.

According to a preferred embodiment, an adjustment device is provided for changing a flow cross section of the discharge path, wherein for the regeneration process, the flow cross section of the discharge path is set to a predefined value by means of the adjustment device. The regeneration process is also supported in that the flow speed through the discharge path can be changed. Thus, preferably, the flow cross section of the discharge path is set to a value which is smaller than a nominal dimension of the discharge path. Because of the constriction of the discharge path, the quantity of compressed air in the dryer requires more time to flow out of the compressed air supply device. In this way, the compressed air in the dryer can absorb and extract more moisture, whereby the regeneration process takes place more efficiently. This is preferably achieved in that the flow cross section of the discharge path is set to the predefined value by means of a choke as the adjustment device.

An alternative embodiment provides that an adjustment device is provided for changing a flow cross section of the discharge path, wherein for the regeneration process, the flow cross section of the discharge path is set by means of the adjustment device to a value which depends on a duration predefined for the regeneration process or on a pressure prevailing in the dryer. The flow cross section is thus set in targeted fashion to a value which is determined depending on a duration for the regeneration process or a pressure in the dryer. If only a certain time is available for the regeneration process, the flow cross section of the discharge path is set to a specific value so that a defined quantity of compressed air flows out and the dryer is optimally regenerated. Also, the pressure value in the dryer may be determined by means of a pressure sensor, so that a defined quantity of compressed air escapes because of the setting of the flow cross section of the discharge path. Thus preferably, the value for the flow cross section of the discharge path is set such that the compressed air quantity escapes from the dryer at 10 to 20 bar/min.

Preferably, the value for the flow cross section of the discharge path is set variably during the regeneration process by means of the adjustment device. As required, the flow cross section of the discharge path may also be set variably over the duration of the regeneration process. Thus for example at the start of the regeneration process, the flow cross section of the discharge path may be set as small as possible, and as soon as the pressure in the dryer diminishes, the flow cross section of the discharge path may be opened so that the remaining quantity of compressed air can flow out quickly. The temporal or pressure-dependent setting of the flow cross section of the discharge path, which may also be variable over the duration, is preferably achieved by a proportional valve as an adjustment device which sets the value for the flow cross section of the discharge path.

A further aspect of the invention is the provision of a compressed air supply device for an air suspension system of a motor vehicle, comprising a motor-driven compressor and a dryer, wherein a discharge path leads from the dryer to the outside, wherein an adjustment device for changing a flow cross section of the discharge path is provided in the discharge path. Advantageously, for regeneration of the dryer, an adjustment device for changing the flow cross section of the discharge path is provided so that the regeneration process takes place optimally. Because of the changing flow cross section, in particular the constriction, the quantity of compressed air present in the dryer takes longer to escape than with the nominal dimension of the discharge path. Thus the compressed air absorbs more moisture from the dryer and releases this to the environment, reducing the saturation level of the dryer. Preferably, therefore, the adjustment device for changing the flow cross section of the discharge path is configured as a choke.

According to a preferred embodiment, a first discharge valve, which is provided in a first path portion of the discharge path, is then arranged between the choke and the dryer. The first discharge valve allows opening of the first path portion for regeneration of the dryer, wherein the quantity of compressed air contained in the dryer escapes via the choke.

Preferably, a second path portion is provided in the discharge path which runs parallel to the first path portion, wherein a second discharge valve is arranged in the second path portion. The second path portion is then used for the regular flushing process of the dryer or for the discharge of compressed air from the air suspension system. Here, the first discharge valve remains closed and the second discharge valve is opened. Thus the maximum possible flow cross section is available for the discharge of compressed air from the air suspension system.

As an alternative to the embodiment with the two parallel path portions of the discharge path, a proportional valve may also be used as an adjustment device for changing a flow cross section of the discharge path. The proportional valve allows the discharge path to be used for the regeneration process and also for the regular flushing process, since the proportional valve can set the flow cross section steplessly from closed to completely open.

The air suspension system is electronically controllable by a control device which serves to actuate the adjustment device, the discharge valves and the compressor.

The compressed air supply device is used in an air suspension system for a motor vehicle.

### BRIEF DESCRIPTION OF THE DRAWINGS

Further preferred embodiments of the invention are provided by the following description of exemplary embodiments on the basis of the figures.

In the drawings:

FIG. 1 shows a pneumatic circuit diagram of an air suspension system with a first exemplary compressed air supply device, and

FIG. 2 shows a pneumatic circuit diagram of an air suspension system with a second exemplary compressed air supply device.

### DETAILED DESCRIPTION

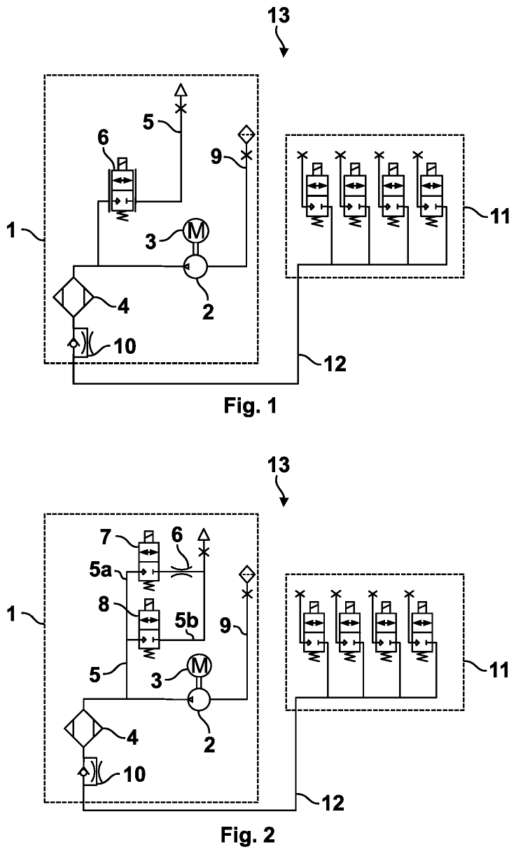

FIG. 1 shows a pneumatic circuit diagram of an electronically controllable air suspension system 13 of a motor vehicle, which may work in the open or closed air supply mode. The air suspension system 13 comprises a compressed air supply unit 1 and an air spring device 11 which are connected together via a connecting line 12. The air spring device 11 comprises air springs (not shown), which are each assigned to a respective wheel of the motor vehicle, and the air spring valves which are shown. A pressure accumulator (not shown), which can be connected to the connecting line 12, may form part of the air suspension system 13. In this case, a changeover valve device (not shown) comprising at least four 2/2-way directional valves is then provided. The compressed air supply unit 1, the air spring device 11 and the pressure accumulator are connected to this changeover valve device. The air suspension system 13 also includes a control unit (ECU) (not shown) which actuates the valves of the air suspension system 13 and the compressor 2.

The compressed air supply unit 1 comprises a compressor 2 which is driven by a motor 3. Furthermore, the compressed air supply unit 1 comprises a dryer 4 and a choke check valve device 10. In order to convey compressed air into the air suspension system 13, an inlet path 9 is provided which leads to the input side of the compressor 2. Compressed air is discharged to the atmosphere from the air suspension system 13 via a discharge path 5. The discharge path 5 branches from a pressure path between the compressor 2 and the dryer 4, and leads to the outside into the environment of the compressed air supply unit 1.

In order to provide compressed air for the air suspension system 13, the compressor 2 draws air in from the atmosphere/environment via the inlet path 9, compresses this and supplies it to the air spring device 11 via the dryer 4. This is called the compression process.

During the compression process, the moisture contained in the air is adsorbed by the dryer 4. This is achieved using an adsorbent which is stored in the dryer 4. Above a certain quantity of moisture or water bound in the adsorbent, the dryer 4 must be regarded as saturated. It must therefore be regenerated. In other words, the moisture contained in the dryer 4 must be discharged. This is usually achieved by conducting compressed air through the dryer 4 in the counterflow direction (i.e. against the compression direction), which then escapes to the atmosphere/environment via the discharge path 5. Normally, for such a “flushing process”, compressed air is taken from the air spring device 11 or from the pressure accumulator. Then when the air spring valves are opened, the compressed air escapes into the environment from the air spring device 11 via the connecting line 12, choke check valve device 10, dryer 4 and discharge path 5. The compressed air flowing through the dryer 4 absorbs the moisture from the adsorbent and releases it to the environment. This flushing process however is not very efficient because of the high flow speed of the compressed air and the low temperature of the compressed air.

In order to ensure a better regeneration of the dryer 4 or to support the normal flushing process, according to the example, a regeneration process is performed which takes place exclusively with compressed air present in the dryer 4. If a certain quantity of compressed air is present in the dryer 4, this is advantageously used for capturing moisture and releasing this to the atmosphere from the dryer 4 via the discharge path 5. For this process, the air spring valves of the air spring device 11 are closed, while the discharge path 5 is open. Thus only the quantity of compressed air contained in the dryer 4 escapes and releases back to the environment the moisture absorbed in the dryer 4 during the compression process. If a pressure accumulator with a changeover valve device is present in the air suspension system 13, the valves of the changeover valve device, above all the pressure accumulator valve, remain closed so that when the discharge path 5 is open, only the compressed air escapes from the dryer 4. This ensures that no compressed air quantity, which would still be required for control processes for adjusting the height of the motor vehicle, escapes from the air suspension system 13.

This regeneration process using exclusively compressed air from the dryer 4 already lowers the level of dryer saturation irrespective of any temporally subsequent flushing processes. This exemplary regeneration process constitutes a supplement to the usual flushing process with compressed air from the air suspension system 13, whereby the regeneration of the dryer 4 as a whole is improved. The exemplary regeneration process may be performed when it is found that the dryer 4 is overloaded with moisture. This is either established by a fault in the normal flushing process or monitored by software.

The exemplary regeneration process is supported in that this is performed with heated compressed air. Such a quantity of heated compressed air is present in the dryer 4 following a compression process. During compression, the air is heated and the now heated compressed air is conducted through the dryer 4. Then the compressed air is distributed into the pressure chambers (air springs or pressure accumulators), whereby this compressed air mixes with the cold air already present in the pressure chambers and is thereby cooled. However, a certain quantity of compressed air remains in the dryer 4, and has a higher temperature value than the ambient temperature and than the compressed air in the pressure chambers. For example, directly after system filling, a regeneration process is carried out which ensures partial regeneration of the dryer 4 using the heated compressed air present in the dryer 4.

The exemplary regeneration process is supported further by controlling the discharge speed in the discharge path 5. For example, for this an adjustment device 6 is provided in the discharge path 5, by means of which a flow cross section of the discharge path 5 is variable. By changing the flow cross section of the discharge path 5 from wide open to almost closed, the discharge speed of the compressed air from the dryer 4 can be set. The temporally slower the quantity of compressed air can escape from the dryer 4, the more moisture is extracted. If the pressure prevailing in the dryer is dissipated slowly, the concentration of the moisture present in the desiccant and the compressed air present in the dryer 4 can be balanced as efficiently as possible. This progress of the exemplary regeneration process is controlled either by measurement of the pressure prevailing in the dryer 4 or by temporal control.

For example, therefore, with respect to the device, a compressed air supply device 1 is proposed which provides an adjustment device 6 in the discharge path 5. Preferably, the adjustment device 6 is configured as a choke or as a proportional valve. A choke or a proportional valve allows constriction of the flow cross section of the discharge path 5 so that the quantity of compressed air present in the dryer 4 flows out for as long as possible. In the configuration of the discharge path 5 of the compressed air supply device 1 according to FIG. 1, a proportional valve is suitable as an adjustment device 6 because this allows complete opening of the flow cross section of the discharge path 5, so that a large quantity of compressed air can escape from the air spring device 11 as quickly as possible for a height adjustment process. On the other hand, for a particularly efficient regeneration process, the flow cross section of the discharge path 5 can be set as narrow as possible, so that the compressed air present in the dryer 4 absorbs and extracts as much moisture as possible.

Alternatively, another configuration of the discharge path 5 is proposed in the compressed air supply device 1 of FIG. 2. Two path portions 5a and 5b, which run parallel to one another, are provided in the discharge path 5. A first discharge valve 7 and an adjustment device 6 are provided in the first path portion 5a. Only a second discharge valve 8 is provided in the second path portion 5b.

For the exemplary regeneration process, the first path portion 5a is used for regeneration with compressed air present in the dryer 4. In other words, the first discharge valve 7 is opened while the second discharge valve 8 remains closed. Thus the quantity of compressed air escapes from the dryer 4 to the environment only through the first path portion 5a. For this, the compressed air must pass through an adjustment device 6, which in FIG. 2 is configured as a choke. The discharge path 5 with path portion 5a thus serves for a lengthy discharge of compressed air, so that the dryer 4 is optimally regenerated.

For a height change process of the air suspension system 11 or for a regular flushing process of the dryer 4, the second path portion 5b of the discharge path 5 is then used. In other words, the first discharge valve 7 remains closed while the second discharge valve 8 is open. Since no adjustment device constricting the flow cross section is provided in the second path portion 5b, the compressed air can escape to the environment via this path as quickly as possible.

1-9. (canceled)

10. A compressed air supply device for an air suspension system of a motor vehicle, the compressed air supply device comprising:
a motor-driven compressor;
a dryer,
a discharge path from the dryer to an outside environment; and
an adjustment devices for changing a flow cross section of the discharge path provided in the discharge path.

11. The compressed air supply device as claimed in claim 10, wherein the adjustment device is a choke.

12. The compressed air supply device as claimed in claim 10, further comprising a first discharge valve arranged in a first path portion of the discharge path between the choke and the dryer.

13. The compressed air supply device as claimed in claim 12, further comprising a second discharge valve arranged in a second path portion of the discharge path parallel to the first path portion.

14. The compressed air supply device as claimed in claim 10, wherein the adjustment device is a proportional valve.

15. (canceled)
